(19) United States
(12) Patent Application Publication
(10) Pub. No.: US 2011/0224043 A1
(43) Pub. Date: Sep. 15, 2011

(54) HYBRID MODULE FOR THE HYBRID DRIVE TRAIN OF A MOTOR VEHICLE

(76) Inventors: Max Bachmann, Bad Waldsee (DE); Bernard Hunold, Friedrichshafen (DE); Kai Borntraeger, Langenargen (DE); Rene Budach, Ravensburg (DE)

(21) Appl. No.: 13/126,587

(22) PCT Filed: Oct. 26, 2009
(86) PCT No.: PCT/EP2009/064074

§ 371 Date: Jun. 1, 2011

(30) Foreign Application Priority Data
Oct. 29, 2008 (DE) 10 2008 043 290.3

(51) Int. Cl. B60K 6/50

(52) U.S. Cl. 475/149; 903/910

(57) ABSTRACT

A hybrid module for the hybrid drive train of a motor vehicle is proposed, comprising an electric motor, a planetary gear assembly and a clutch (6) which connects the drive shaft of the internal combustion engine to the planet carrier (5) of the planetary gear assembly in a releasable manner, wherein the mounting for the rotor (1) and stator (2) is provided by the electric motor by way of the cover (3) of the electric motor, whereby the hub of the rotor (1) serves as the ring gear of the planetary gear assembly of the hybrid module and features a ring gear gearing and whereby the subassembly, comprised of the cover (3), the rotor (1) and the stator (2) can be preassembled.

The present invention relates to a hybrid module for the hybrid drive train of a motor vehicle according to the preamble of claim 1.

The building of motor vehicle transmissions in a modular design is known from the prior art; for example, with automatic torque converter transmissions the torque converter is built into the converter housing as a separate module. With the modular design there is the advantage that the individual aggregates of a motor vehicle transmission can be inspected regarding their functional efficiency.

The present invention has the objective of providing a hybrid module for the hybrid drive train of a motor vehicle which can be preassembled separately and can be integrated in a conventional automatic transmission. In particular, the hybrid module according to the invention should be able to be integrated in the converter housing of the transmission in place of the converter and have, essentially, gear interfaces identical to those of the converter.

This objective is achieved through the characteristics of claim 1. Further embodiments and advantages according to the invention are to be derived from the dependent claims.

Accordingly, a hybrid module is proposed, comprising an electric motor with a rotor and a stator, a planetary gear assembly and a clutch which connects the drive shaft with the internal combustion engine in a releasable manner, wherein the mounting for the rotor and stator of the electric motor is provided by way of the cover of the electric motor, wherein the hub of the rotor serves as the ring gear of the planetary gear assembly and exhibits a ring gear gearing, and the subassembly, including the cover, the rotor and the stator can be preassembled. For this the drive shaft of the internal combustion engine can be inserted in the cover and can be held in place by means of a device suited for this, preferably by means of a snap ring.

Furthermore, the hybrid module comprises a second subassembly which can be preassembled, having the sun gear, the planet carrier of the planetary gear assembly of the hybrid module and the clutch, whereby the pump wheel for the mechanically driven transmission oil pump is preferably coupled to the planet carrier; on the one hand, the planet carrier is connected to the outer disk carrier of the clutch and on the other hand, is connected to the transmission input.

The second subassembly can be deployed, according to the invention, for the installation of the hybrid module in the rotor of the electric motor, whereby the gearing of the inner disk carrier of the clutch meshes with the gearing of the inner disks, and the ring gear gearing of the rotor hub meshes with the gearing of the planets of the planet carrier of the planetary gear assembly. The sun gear of the planetary gear assembly is stationary according to the invention.

The hybrid module built in this manner can be subsequently built into the converter housing of an automatic transmission and replace the converter.

The invention shall be explained in greater detail below, exemplified using the attached illustrations. They show:

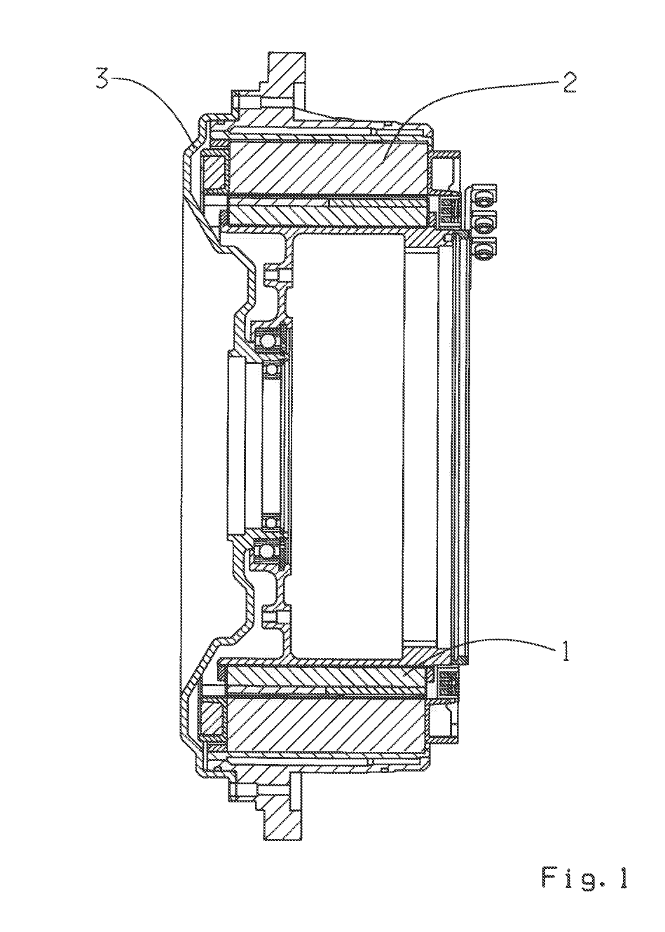

FIG. 1: A perspective cross-section of the subassembly comprising the rotor, the stator, and the cover of the electric motor;

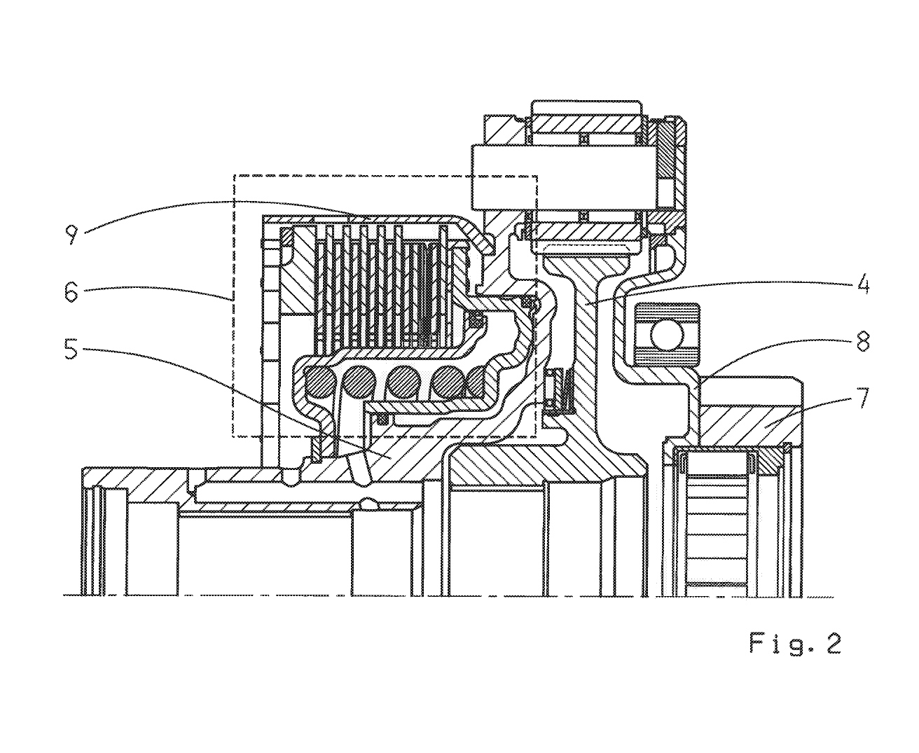

FIG. 2: A cross-section of the second subassembly comprising the sun gear, a planet carrier of a planetary gear assembly and a clutch; and

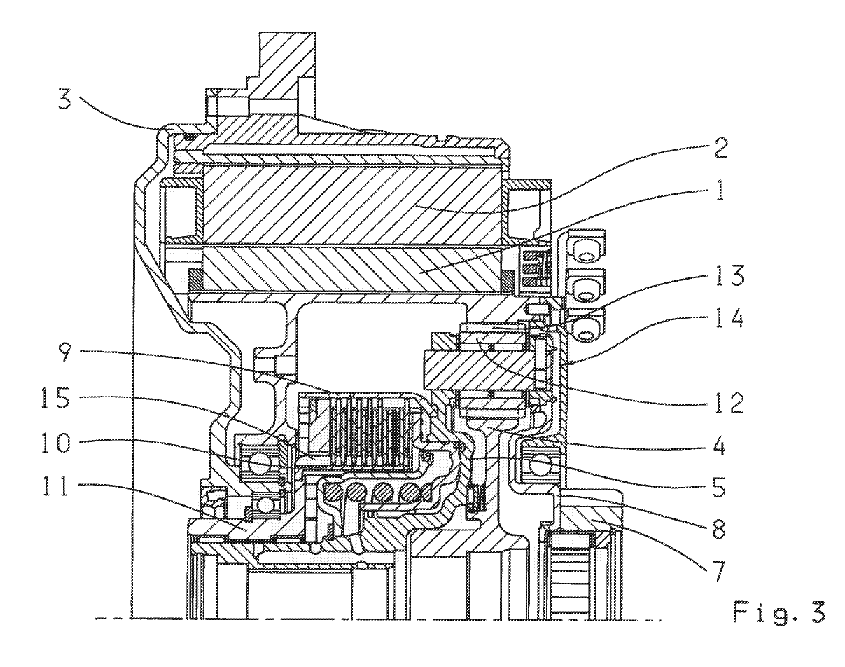

FIG. 3: A cross-section of the hybrid module in the installed state.

FIG. 1 shows an assembled subassembly of a hybrid module which can be preassembled, according to the invention, comprising the rotor 1, the stator 2, and the cover 3 of the electric motor, whereby the cover 3 forms the mounting for the rotor 1 and the stator 2. According to the invention, the hub of the rotor 1 serves as the ring gear of the planetary gear assembly of the hybrid module and features the gear teeth of a ring gear. The ring gear gearing is shown in FIG. 3 and has the reference number 13.

The subject matter of FIG. 2 is the second subassembly of a hybrid module, which can be preassembled, having a sun gear 4 and a planet carrier 5 of the planetary gear assembly of the hybrid module as well as a clutch 6; as can be seen in FIG. 2, in the example shown, the pump wheel 7 of the mechanically driven transmission oil pump is coupled to the planet carrier 5 by means of a tappet 8. Furthermore, the planet carrier 5 is connected to the outer disk carrier 9 of the clutch 6 and to the transmission input, whereby the sun gear of the planetary gear assembly is stationary.

The two preassembled subassemblies can be connected to each other for the installation of the hybrid module in that the second subassembly is placed in the rotor of the electric motor, whereby the inner disk carrier 10 of the clutch 6 meshes with the gearing 15 of the inner disks of the clutch 6 and the ring gear gearing 13 of the rotor hub meshes with the gearing of the planets 12 of the planet carrier 5, as is illustrated in FIG. 3. In FIG. 3, the number 14 indicates a transmitter wheel which is fixed in position by means of a cylinder pin and a retaining ring, whereby these components are attached after assembly of the preassembled subassemblies; furthermore, the reference number 11 indicates the drive shaft which is connected to the inner disk carrier 10.

In this manner, a hybrid module for the hybrid drive train of a motor vehicle is provided which can be separately preassembled and integrated in a conventional automatic transmission in place of the torque converter. Because the hybrid module consists of two subassemblies, these can be inspected separately regarding functional efficiency prior to the installation of the hybrid module. Furthermore, the installed hybrid module can be built into the converter housing of an automatic transmission without the need for further constructional measures, and thereby replace the converter.

As a matter of course any constructional developments, in particular any spatial arrangement of the components of the hybrid module in and of themselves or in relation to one another and insofar as they are technically reasonable, fall under the scope of protection of the present claims, without affecting the function of the hybrid module as is given in the claims, even if said embodiment is not explicitly presented in the figures or in the description.

### REFERENCE SYMBOLS

1 Rotor
2 Stator
3 Cover
4 Sun wheel
5 Planet carrier
6 Clutch
7 Pump wheel
8 Tappet
9 Outer disk carrier
10 Inner disk carrier
11 Drive shaft
12 Planet
13 Ring gear gearing
14 Transmitter wheel
15 Gearing of the inner disks

1. A hybrid module for a hybrid drive train of a motor vehicle, comprising an electric motor, a planetary gear assembly and a clutch, which connects a drive shaft of an internal combustion engine to a planet carrier of the planetary gear assembly in a releasable manner, characterized in that the mounting for a rotor and a stator of the electric motor is provided by way of a cover of the electric motor, whereby a hub of the rotor serves as a ring gear of the planetary gear assembly and features a ring gear gearing, and wherein the assembly comprising the cover, the rotor and the stator can be preassembled.

2. The hybrid module for the hybrid drive train of a motor vehicle according to claim 1, wherein the drive shaft of the internal combustion engine is insertable into the cover and fixed in position.

3. The hybrid module for the hybrid drive train of a motor vehicle according to claim 1, further comprising a second subassembly, which can be preassembled, comprising a sun gear and the planet carrier of the planetary gear assembly of the hybrid module, and the clutch, wherein the planet carrier is connected to an outer disk carrier of the clutch and a transmission input, and wherein the sun gear is stationary.

4. The hybrid module for the hybrid drive train of a motor vehicle according to claim 3, wherein the planet carrier is coupled by means of a tappet to a pump wheel of a mechanically driven transmission oil pump.

5. The hybrid module for the hybrid drive train of a motor vehicle according to claim 3, wherein the second subassembly may be deployed for the installation of the hybrid module in the rotor of the electric motor, and wherein an inner disk carrier of the clutch meshes with a gearing of a inner disks of the clutch and a ring gear gearing of a rotor hub meshes with a gearing of the planets of the planetary gear assembly.

6. The hybrid module for the hybrid drive train of a motor vehicle according to claim 1, wherein the hybrid module is built into a converter housing of an automatic transmission, whereby a converter is replaced.
